(19) United States
(12) Patent Application Publication
(10) Pub. No.: US 2009/0139585 A1
(43) Pub. Date: Jun. 4, 2009

(54) INTEGRATED AIR TANK

(75) Inventors: Leo P. Oriet, Rochester Hills, MI (US); Jules Cazabon, Staples (CA)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/949,103

(22) Filed: Dec. 3, 2007

(51) Int. Cl. B60T 17/00

(52) U.S. Cl. 137/512

(57) ABSTRACT

An integrated air tank (10) for an air supply system of a vehicle brake system includes a tank housing (12) subdivided into at least three portions with a first separator wall (24) and a second separator wall (26). The at least three portions include a primary tank portion (18), a secondary tank portion (22), and a wet tank portion (20). A first check valve (28) is disposed on the first separator wall (24) and is configured to permit the flow of air from the wet tank portion (20) to the primary tank portion (18). A second check valve (30) is disposed on the second separator wall (26) and is configured to permit the flow of air from the wet tank portion (20) to the secondary tank portion (22).

### FIELD OF THE INVENTION

This invention relates to air brakes for motor vehicles. More particularly, this invention relates to an air supply system for air brakes.

### BACKGROUND OF THE INVENTION

Heavy duty trucks use air to operate the vehicle service brakes and other auxiliaries. The air is provided from a vehicle air system, which includes an air compressor that supplies air to a wet tank. The wet tank is in fluid communication with a primary air tank and a secondary air tank through separate, exterior check valves. The check valves allow air to flow only from the wet tank to the primary tank and the secondary tank. Air from the primary tank and the secondary tank is supplied through tubing to operate the vehicle brake system and other air operated auxiliaries.

In the prior art, the air tanks are attached to cross struts on a chassis in a parallel arrangement. Air lines are provided for interconnecting the tanks. Together, the tanks would typically have at least fourteen openings in the end caps of the tanks. Each opening would typically include an air line push fitting. Each of the at least fourteen push fittings would be at risk of air leaks, contributing to avoidable warranty costs to the manufacturer. Additionally, the push fittings and the air lines would commonly be subjected to significant bending forces as the lines would have to be run wherever there was room available on the vehicle frame. Further, the required time to assemble the air tanks and the associated air lines translated to costs to the vehicle production.

### SUMMARY OF THE INVENTION

An integrated air tank for an air supply system of a vehicle brake system includes a tank housing subdivided into at least three portions with a first separator wall and a second separator wall. The at least three portions include a primary tank portion, a secondary tank portion, and a wet tank portion. A first check valve is disposed on the first separator wall and is configured to permit the flow of air from the wet tank portion to the primary tank portion. A second check valve is disposed on the second separator wall and is configured to permit the flow of air from the wet tank portion to the secondary tank portion.

### BRIEF DESCRIPTION OF THE DRAWINGS

FIG. 1 is a front perspective view of a prior art air tank assembly.

FIG. 2 is a schematic drawing of an integrated air tank in accordance with the invention.

### DESCRIPTION OF A PREFERRED EMBODIMENT

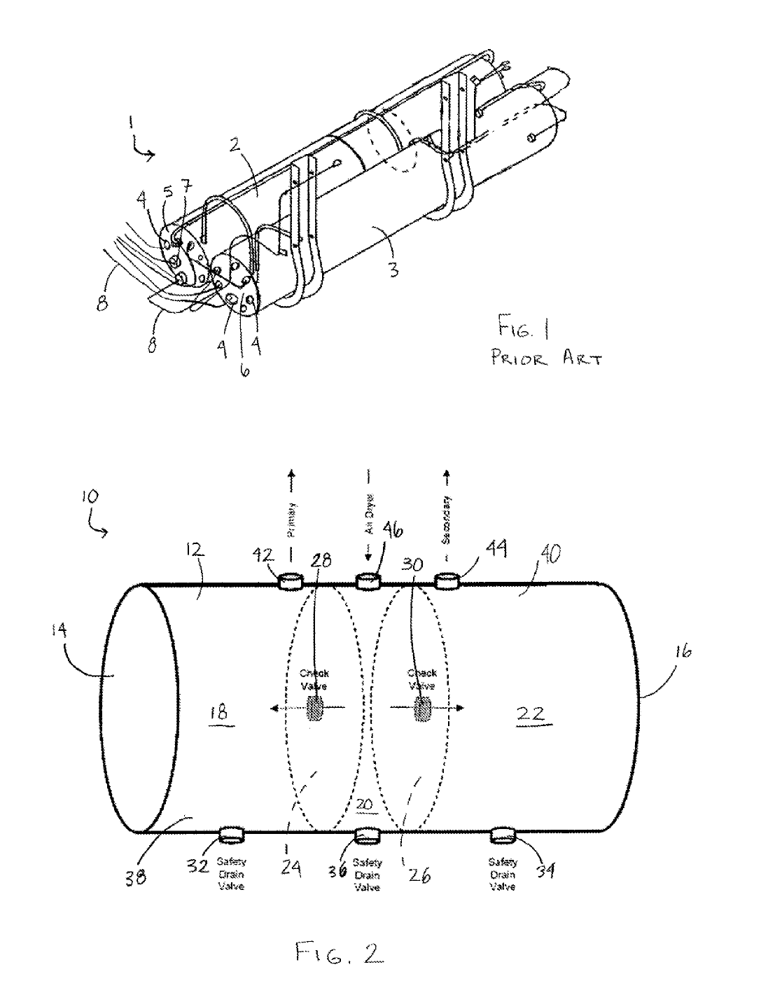

Referring to FIG. 1, a prior art air tank assembly 1 has a first air tank 2 and a second air tank 3 disposed parallel to the first air tank. Multiple openings 4 are disposed on the end caps 5, 6 of the first air tank 2 and the second air tank 3, respectively. There are also holes (not shown) at the other end of the first air tank 2 and the second air tank 3. In the tank assembly of FIG. 1, there are about fourteen openings 4 on the end caps 5, 6 which receive push fittings 7 and air lines 8. Each of the fourteen push fittings 7 and their associated air lines 8 are at risk of air leaks and in-service damage.

Turning now to FIG. 2, the following describes an integrated air tank 10 for use in an air supply system of a vehicle. The integrated air tank 10 is generally cylindrical, although the shape can vary.

The integrated air tank 10 includes a tank housing 12 with a first end cap 14 and a second end cap 16. The tank housing 12 is separated into three portions: a primary tank portion 18, a wet tank portion 20, and a secondary tank portion 22. A first separator wall 24 is generally parallel to the first end cap 14 and separates the primary tank portion 18 from the wet tank portion 20, and a second separator wall 26 is generally parallel to the second end cap 16 and separates the secondary tank portion 22 from the wet tank portion 20. The primary tank portion 18, the wet tank portion 20, and the secondary tank portion 22 are generally cylindrically shaped portions, although the shapes can vary.

Disposed on the first separator wall 24 and the second separator wall 26 is a first check valve 28 and a second check valve 30, respectively. The first check valve 28 permits air to flow only from the wet tank portion 20 to the primary tank portion 18, and the second check valve 30 permits the air to flow only from the wet tank portion 20 to the secondary tank portion 22.

A first safety drain valve 32 is disposed on the tank housing 12 in the primary tank portion 18, a second safety drain valve 34 is disposed on the tank housing in the secondary tank portion 22, and a third safety drain valve 36 is disposed on the tank housing in the wet tank portion 20. Advantageously, all three safety drain valves 32, 34, 36 are aligned on the tank housing 12 at a lower portion 38 of the tank housing.

On an upper portion 40 of the tank housing 12, there is a primary outlet port 42, a secondary outlet port 44, and an air dryer inlet port 46. The primary outlet port 42 is disposed on the primary tank portion 18, and the secondary outlet port 44 is disposed on the secondary tank portion 22. The primary outlet port 44 and the secondary outlet port 46 are configured for emitting air for use in braking and auxiliaries. The air dryer inlet port 46 is disposed on the wet tank portion 20. The air dryer inlet port 46 is configured to receive compressed air from a compressor (not shown).

When the integrated air tank 10 is positioned on the vehicle (not shown) tubing or other connectors (not shown) can be attached to the ports. As seen in FIG. 2, the number of threaded holes in the integrated air tank 10 is six, as opposed to a conventional air tank assembly having about fourteen. The integrated air tank 10 eliminates the air line clutter associated with the prior art by providing a clean exterior tank housing 12, particularly at the end caps 14, 16.

The integrated air tank 10 reduces the complexity of the air supply system by reducing the total number of parts, reducing the number of assembly steps, reducing the product weight, and reducing the total number of fasteners. The integrated air tank 10 decreases the assembly costs while improving the product quality. Further, there are no exposed air lines at the end caps 14, 16 of the tank housing 12 that are at risk of being accidentally tangled or disengaged.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An integrated air tank for an air supply system of a vehicle brake system, comprising:
a tank housing subdivided into at least three portions with a first separator wall and a second separator wall, the at least three portions comprising a primary tank portion, a secondary tank portion, and a wet tank portion;
a first check valve disposed on the first separator wall and configured to permit the flow of air from the wet tank portion to the primary tank portion; and
a second check valve disposed on the second separator wall and configured to permit the flow of air from the wet tank portion to the secondary tank portion.

2. The integrated air tank of claim 1 wherein the tank housing is generally cylindrical with a first end cap and a second end cap.

3. The integrated air tank of claim 2 wherein the first separator wall and the second separator wall are generally parallel with the first end cap and the second end cap.

4. The integrated air tank of claim 1 further comprising a first safety drain valve disposed on the tank housing in the primary tank portion, a second safety drain valve disposed on the tank housing in the secondary tank portion, and a third safety drain valve disposed on the tank housing in the wet tank portion.

5. The integrated air tank of claim 4 wherein the first, second and third safety drain valves are aligned on the tank housing at a lower portion of the tank housing.

6. The integrated air tank of claim 1 further comprising a primary outlet port disposed on the primary tank portion.

7. The integrated air tank of claim 1 further comprising a secondary outlet port disposed on the secondary tank portion.

8. The integrated air tank of claim 1 further comprising an air dryer inlet port disposed on the wet tank portion.

9. The integrated air tank of claim 1 further comprising an upper portion of the tank housing, wherein a primary outlet port is disposed on the primary tank portion at the upper portion of the tank housing.

10. An integrated air tank for an air supply system of a vehicle brake system, comprising:
a generally cylindrical tank housing subdivided into three generally cylindrical portions with a generally circular first separator wall and a generally circular second separator wall, the three portions comprising a primary tank portion, a secondary tank portion, and a wet tank portion;
a first check valve disposed on the first separator wall and configured to permit the flow of air from the wet tank portion to the primary tank portion; and
a second check valve disposed on the second separator wall and configured to permit the flow of air from the wet tank portion to the secondary tank portion.

11. The integrated tank of claim 10 wherein the tank housing has a first end cap and a second end cap.

12. The integrated air tank of claim 11 wherein the first separator wall and the second separator wall are generally parallel with the first end cap and the second end cap.

13. The integrated air tank of claim 10 further comprising a first safety drain disposed on the tank housing in the primary tank portion, a second safety drain disposed on the tank housing in the secondary tank portion, and a third safety drain disposed on the tank housing in the wet tank portion.

14. The integrated air tank of claim 13 wherein the first, second and third safety drains are aligned on the tank housing at a lower portion of the tank housing.

15. The integrated air tank of claim 10 further comprising a primary outlet port disposed on the primary tank portion.

16. The integrated air tank of claim 10 further comprising a secondary outlet port disposed on the secondary tank portion.

17. The integrated air tank of claim 10 further comprising an air dryer inlet port disposed on the wet tank portion.

18. The integrated air tank of claim 10 further comprising an upper portion of the tank housing, wherein a primary outlet port is disposed on the primary tank portion at the upper portion of the tank housing.

19. The integrated air tank of claim 18 wherein an air dryer inlet port is disposed on the upper portion of the tank housing at the wet tank portion.

20. An integrated air tank for an air supply system of a vehicle brake system, comprising:
a tank housing having an upper portion and a lower portion, the tank housing being subdivided into three portions with a first separator wall and a second separator wall, the three portions comprising:
a primary tank portion having a first safety drain valve on the lower portion and a primary outlet port on the upper portion;
a secondary tank portion having a second safety drain valve on the lower portion and a secondary outlet port on the upper portion; and
a wet tank portion having a third safety drain valve on the lower portion and an air dryer inlet port on the upper portion;
a first check valve disposed on the first separator wall and configured to permit the flow of air from the wet tank portion to the primary tank portion; and
a second check valve disposed on the second separator wall and configured to permit the flow of air from the wet tank portion to the secondary tank portion.
